(19) United States
(12) Patent Application Publication
(10) Pub. No.: US 2008/0055427 A1
(43) Pub. Date: Mar. 6, 2008

(54) VIDEO DIARY

(76) Inventor: Heino Wendelrup, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/469,963

(22) Filed: Sep. 5, 2006

(51) Int. Cl. H04N 5/225

(52) U.S. Cl. 348/231.2; 348/207.99

(57) ABSTRACT

A method of generating a video-based diary of a user's activities based on various information stored and/or collected by a mobile phone. More particularly, the invention provides a method of generating a video-based diary of a period of time based on information such as, for example, incoming, outgoing, and missed calls, voicemails, sent and received text messages, pictures, sound and/or video clips, location, emails, etc. The format and content included in the generated video-based diary can be predetermined by the user so that only desired stored information is included in the video-based summary. The generated video-based diary can be utilized by the user in the future as a reference for remembering past events. The generated video-based diary can also be uploaded via the phone to a blog, if so desired.

### TECHNICAL FIELD OF THE INVENTION

The present invention relates generally to electronic equipment and, more particularly, to electronic equipment and a method of generating a video-based diary of information collected by the electronic equipment.

### DESCRIPTION OF THE RELATED ART

Conventional mobile phones, in addition to providing voice communication capabilities, also provide a number of non-voice related features. For example, mobile phones can be used to “surf” the internet, transmit and receive messages (e.g., emails and text messages (SMS)), play music and videos, take and display photographs, track location using GPS (or other means), as well as a number of other features. Many mobile phones include other tools such as calendars, alarm clocks, notepads, etc. Some phones also include a keyboard and a CPU that gives the phone personal computer-like functionality.

As a result of the increased functionality of mobile phones, users are becoming more and more reliant on such devices. Indeed, for many people a mobile phone is an essential part of their everyday life. For example, in a given day a phone alarm clock may wake a user in the morning and the phone calendar may remind the user of various tasks to be performed during the day. The user may then use the phone to place calls throughout the day to work associates and family members. Various text messages may be sent between the user and various acquaintances of the user. Throughout the course of the day the user may use the mobile phone to read and/or respond to numerous emails. In the evening, the phone might be used to take a picture or video of an interesting event that the user experiences.

Typical phones include logs that record most if not all of such phone activity. Accordingly, at the end of the day (or other relevant time period) the phone contains a substantial amount of information regarding events in the user's day including the times of such events. Although the user may reference some of the information stored in the mobile phone, most of the information currently is not used and is deleted after a period of time or when the respective logs are full. Accordingly, much of the information contained in the phone is erased rather than utilized by the user.

One attempt to utilize this information is set forth in U.S. Pat. No. 7,069,003 to Lehikoinen et al. (“Lehikoinen”). Lehikoinen discloses a method for generating a timeline viewable on the phone's display illustrating various events or activities such as call logs, text messages, etc. The user can utilize the timeline to select desired information that can then be uploaded by the phone and published to the user's blog. Lehikoinen also discloses the use of an animation that is indicative of the use of the mobile station over the period of time. For example, Lehikoinen discloses an animated cat that meows and moves during times at which it is determined that the phone is in high usage, while at times of lower phone activity the cat may be depicted sleeping.

### SUMMARY

The present invention provides a method of generating a video-based diary of a user's activities based on various information stored and/or collected by a mobile phone. More particularly, the invention provides a method of generating a video-based diary of a period of time based on information such as, for example, incoming, outgoing, and missed calls, voicemails, sent and received text messages, pictures, sound and/or video clips, location, emails, etc. The format and content included in the generated video-based diary can be predetermined by the user so that only desired stored information is included in the video-based diary. The generated video-based diary can be utilized by the user in the future as a reference for remembering past events. The generated video-based diary can also be uploaded via the phone to a blog storage devise or transferred to another electronic equipment, if so desired.

According to one aspect of the invention, there is provided a method of generating a video-based diary of user data stored in a memory of an electronic equipment comprising selecting at least one type of user data to be included in the diary, and generating at least one video-based scene using the at least one type of user data. The at least one video-based scene includes at least a portion of the at least one type of user data selected.

According to another aspect, the method further comprises selecting at least one period of time for the diary.

According to another aspect, the at least one type of user data includes call log data, message log data, video/picture log data, MP3 log data, location log data, environmental log data, calendar log data, and voice memo log data.

According to another aspect, the method further comprises downloading user-defined data from the internet, and generating at least one scene including at least a portion of the downloaded data.

According to another aspect, the method further comprises generating a scene in response to information contained in the at least one type of user data.

According to another aspect, generating a scene includes generating a map based upon location information.

According to another aspect, the method further comprises selecting at least one audio file to be included in the at least one video-based scene.

According to another aspect, the selecting at least one audio file includes selecting the file based upon information in an MP3 log stored in the memory.

According to another aspect, the method further comprises uploading the at least one video-based scene to another electronic equipment.

According to another aspect, the method further comprises uploading the at least one video-based scene to the internet.

According to another aspect, the method further comprises associating a link with the at least one scene, wherein the link links to a different scene of the video-based diary.

According to another aspect, the different scene contains additional data related to the user data contained in the scene with the associated link.

According to another aspect, an electronic equipment comprises a memory for storing at least one type of user data, a processor, and a software application stored in the memory and configured to generate a video-based diary including at least one scene containing data from at least one type of user data stored in the memory.

According to another aspect, the at least one type of user data includes call log data, message log data, video/picture log data, MP3 log data, location log data, environmental log data, calendar log data, and voice memo log data.

According to another aspect, the software application is configured to generate a scene in response to information contained in the at least one type of user data.

According to another aspect, the at least one scene includes audio from at least one audio file stored in the memory.

According to another aspect, the software is configured to associate a link with the at least one scene, and wherein the link links to a different generated scene of the video-based diary.

According to another aspect, the electronic equipment is a mobile phone.

According to another aspect, the electronic equipment is at least one of a personal audio device, a personal video device or a personal digital assistant.

To the accomplishment of the foregoing and the related ends, the invention, then, comprises the features hereinafter fully described in the specification and particularly pointed out in the claims, the following description and the annexed drawings setting forth in detail certain illustrative embodiments of the invention, these being indicative, however, of but several of the various ways in which the principles of the invention may be suitably employed.

Other systems, methods, features, and advantages of the invention will be or become apparent to one with skill in the art upon examination of the following drawings and detailed description. It is intended that all such additional systems, methods, features, and advantages be included within this description, be within the scope of the present invention, and be protected by the accompanying claims.

Although the invention is shown and described with respect to one or more embodiments, it is to be understood that equivalents and modifications will occur to others skilled in the art upon the reading and understanding of the specification. The present invention includes all such equivalents and modifications, and is limited only by the scope of the claims.

Also, although the various features are described and are illustrated in respective drawings/embodiments, it will be appreciated that features of the given drawing or embodiment may be used in one or more other drawings or embodiments of the invention.

It should be emphasized that the term “comprise/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is an illustration of an exemplary mobile phone.

FIG. 2 is a schematic illustration of components of an exemplary mobile phone.

FIG. 3 is a schematic illustration of a plurality of scenes of an exemplary generated video-based diary in accordance with an embodiment of the invention.

FIG. 4 is a schematic illustration of a plurality of scenes of another exemplary generated video-based diary in accordance with an embodiment of the invention.

FIG. 5 is a schematic illustration of a plurality of scenes of another exemplary generated video-based diary in accordance with an embodiment of the invention.

### DETAILED DESCRIPTION OF EMBODIMENTS

The present invention will now be described with reference to the drawings, wherein like reference numerals are used to refer to like elements throughout.

The term “electronic equipment” includes portable radio communication equipment. The term “portable radio communication equipment,” which hereinafter is referred to as a “mobile radio terminal,” “mobile phone,” “mobile device,” or “mobile terminal” and the like, includes all equipment such as mobile telephones, pagers, communicators, i.e., electronic organizers, personal digital assistants (PDAs), smartphones, portable communication apparatus or the like. The term “electronic equipment” also may include portable digital music and/or video devices, e.g., iPod devices, mp3 players, etc.

In the present application, the invention is described primarily in the context of a mobile phone. However, it will be appreciated that the invention is not intended to be limited to a mobile phone and can be any type of electronic equipment.

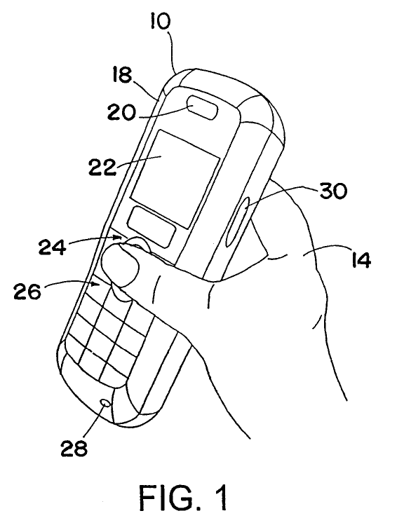

Referring now to FIG. 1, a mobile phone 10 is shown as having a “brick” or “block” design type housing 18 (sometimes referred to as a case), but it will be appreciated that other type housings, such as, for example, clam shell or slide-type housings, may be utilized without departing from the scope of the invention. The mobile phone 10 further includes a speaker 20, display 22, a navigation switch and selection/function keys or switches 24, a key pad 26, a microphone 28, and a side switch 30; these are illustrative and exemplary of parts of a typical mobile phone, but it will be appreciated that other parts that are similar or different in form and/or function may be included in the mobile phone 10. The mobile phones to which the invention pertains also may be of the types that have more or fewer functions, keys, etc., compared to those illustrated and described herein.

As will be appreciated, the mobile phone 10 may function as a conventional mobile phone. The mobile phone 10 may have additional functions and capabilities that may be developed in the future. From a conventional point of view, the display 22 displays information to a user, such as operating state, time, phone numbers, contact information, various navigational menus, etc., which facilitate and/or enable the user to utilize the various features of the mobile phone. The display also may be used to view movies, images, or to play games, for example. Part or all of the display 22 may be a touch screen type device. The navigation and function keys 24 and the keypad 26 may be conventional in that they provide for a variety of user operations. For example, one or more of the function keys and navigation device 24 may be used to navigate through a menu displayed on the display 22 to select different phone functions, profiles, settings, etc., as is conventional. The keypad 26 typically includes one or more special function keys, such as, a “call send” key for initiating or answering a call, a “call end” key for ending or hanging up a call, and dialing keys for dialing a telephone number. Other keys included in the navigation and function keys 24 and/or keypad 26 may include an on/off power key, a web browser launch key, a camera key, a voice mail key, a calendar key, etc. The side switch 30 can be configured to perform any of a wide variety of functions.

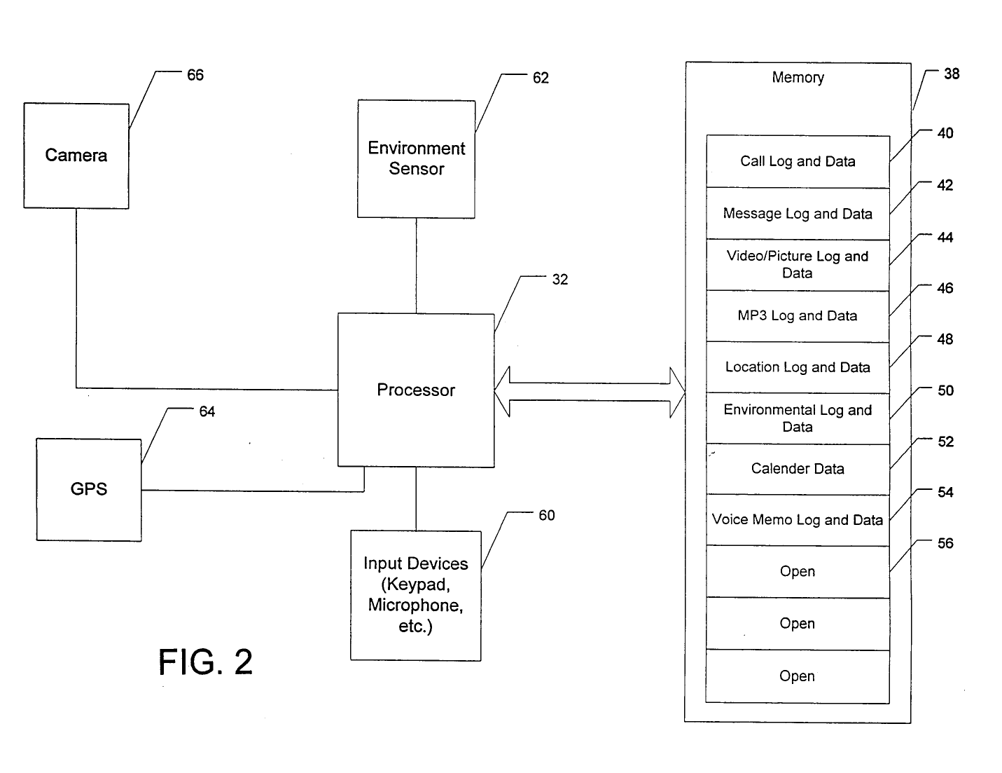

Referring now to FIG. 2, a schematic diagram illustrates some of the components of the mobile phone 10. For the sake of clarity, some of components of a typical mobile phone (e.g., RF transmitter, etc.) have been omitted. The mobile phone 10 includes a processor 32, which can be any type of processor typically associated with mobile phones and/or handheld devices. The processor 32 is coupled via a bus 34 to a memory 36 that stores a variety of data including application software 38 that is used by the processor 32 to generated the video-based diary, as will be described. It will be appreciated that data can be stored in other additional memory banks (not illustrated) and that the memory banks can be of any suitable types, such as read-only memory, read-write memory, etc. The other data stored in memory 36 includes several logs 39 including a call log 40, a text message log 42, a video/picture log 44, an MP3 log 46, a location log 48, an environmental log 50, calendar data 52, and voice memo log 54. It will be appreciated that a wide variety of other types of data can be stored in the memory 36 as desired, and the types of data illustrated are merely exemplary.

The logs stored in the memory 36 can include information such as, for example, the time of the stored event, the number or person to whom or from whom a call or message is sent or received, the content of text messages and/or emails, image and/or video data, temperature and/or elevation data, voice memo audio files, etc. Again, it will be appreciated that the illustrated memory 36 and information stored therein is merely exemplary.

The processor 32 is also connected to a plurality of devices that collect and/or produce the data that is stored in the memory 36. An input device 60, which can be the keypad 26, for example, is connected to the processor for inputting data from the user. In the case of the keypad 26, the inputted data can be alphanumeric characters. Other input devices, such as a microphone, can also be used. An environment sensor 62, which may be a thermometer or a barometer, for example, can be used to collect information about the local environment. A GPS unit is provided for collecting information about the location of the cell phone. A camera is provided for taking pictures and/or video. As will be appreciated, other devices can be provided for generating data. The configuration of the processor 32, related devices, and memory 38 is not germane to the invention, and any arrangement or combination of such components can be used in accordance with the invention.

The events stored in memory 38 generally correspond to the usage of the mobile phone 10 during a given time period, for example a portion of a single day, and are therefore highly indicative of the user's experience during the given time period. Accordingly, a wide variety of event types can be defined including alarms, tasks, appointments, text messages, playing of music files (MP3s), emails, incoming and outgoing calls, reminders, video mail messages, temperature readings, pictures/videos taken, web browser usage, mobile television usage, purchasing of content such as video games and/or music, signal status and/or strength, etc.

It will be appreciated that all of the log entries typically can include a variety of information. For example, the date and time of the event, the sender or recipient of the communication, the location of the phone at the time of the entry, etc. The location information can be specific or general depending on the degree of certainty to which the position of the mobile phone 10 can be ascertained. The user may specify nicknames for certain locations, such as home, office, etc., so that the phone can identify the location in terms more familiar to the user.

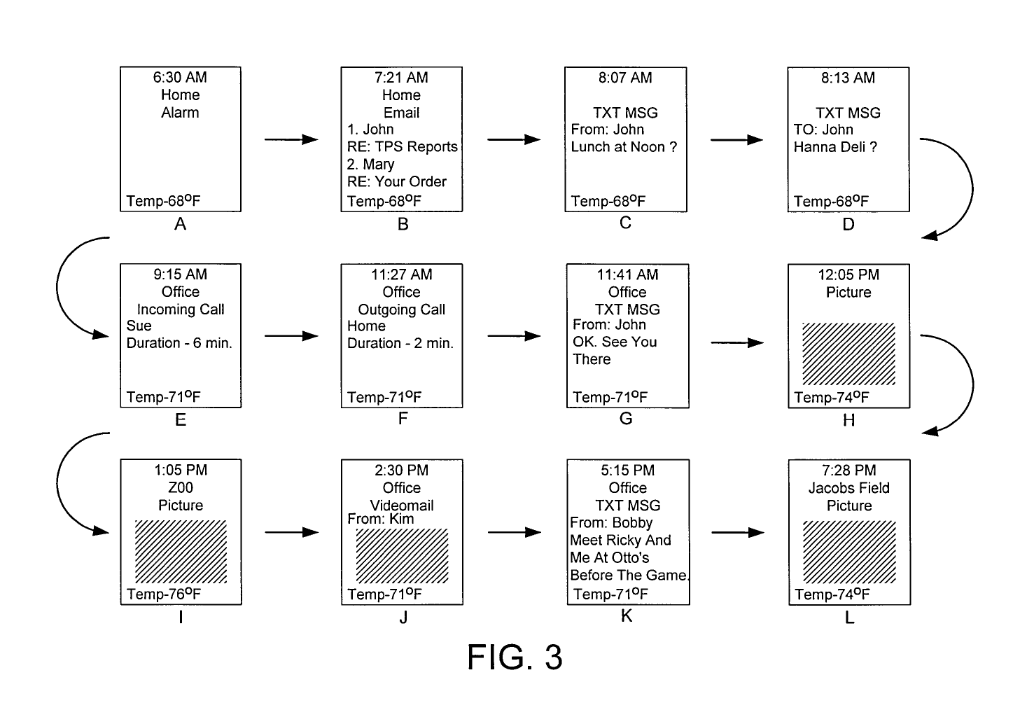

Referring to FIG. 3, and in accordance with an aspect of the invention, an exemplary generated video-based diary 60 is illustrated. The video-based diary 60 includes a plurality of scenes A-L that are generated, as will be described, using events and data stored in the memory 14. The diary 60 can be presented to the user via the display 28 in a video-based format. Each scene A-L corresponds to at least one event and can include location information (e.g., home, work) derived from the location log 48, as well as calendar/clock information (e.g., meetings and other scheduled events) derived from the calendar data 52, outgoing and received call information (time and called or calling party name or number) derived from the call log 40, message data (e.g., received/sent text messages and/or emails) derived from the message log 42, and camera related data such as images and video derived from the video/picture log 44.

By way of example, Scene A depicts an event wherein an alarm is sounded at 6:30 a.m. For the sake of this description, it is assumed that the alarm is the first event that occurs in the time period selected for the video-based diary. The temperature is indicated as being 68° F. and the location is the user's home. If desired, a picture such as an alarm clock can also be presented in Scene A.

It will be appreciated that in any of the scenes, a wide variety of information can be displayed. For example, the time, the location, the event type, and the temperature will typically be displayed if the information is available in memory 38. Other information such as the contents of messages, such as email and text messages may also be displayed. For example, in scene B, two email messages are displayed. Each email message includes the name of the sender and the subject line of the message. Similarly, in scenes C and D, text messages are displayed indicating to or from whom the text message is directed and including the body of the text messages. The location information is absent from scenes C and D because either the location was not ascertained by the mobile phone 10 at that time or the location was not specific enough to permit a location to the designated scenes C and D. Scenes E and F correspond to incoming and outgoing calls, respectively. The duration of each call is also shown. It will be appreciated that if the user has assigned a photograph stored in the memory to a person to whom or from whom a call is placed or received, that person's picture may also be included in the scene. Scene G corresponds to another text message. Scene H corresponds to a picture that was taken at 12:05 p.m., while Scene I corresponds to a picture taken at 1:05 p.m. Scene J corresponds to a video mail message received from a sender named Kim at 2:30 p.m. The video mail message can be animated and displayed in its entirety, as desired. Scene K corresponds to yet another text message. Scene L corresponds to another picture taken at Jacob's Field at 7:28 p.m.

It will be appreciated that each scene can be displayed for a desired length of time, for example, 3 seconds. Scenes A-L generally correspond to events that occurred in chronological order during the time period that the generated video-based diary 60 covers. The scenes can also be grouped together such that similar event types are shown in chronological order. For example, all of the text messaging scenes (scenes C, D, G, and K) can be shown in order, followed by all of the call related scenes, and so on. Similarly, any scenes corresponding to pictures can be shown together and in order. In some cases, a video-based diary of one event type can be generated.

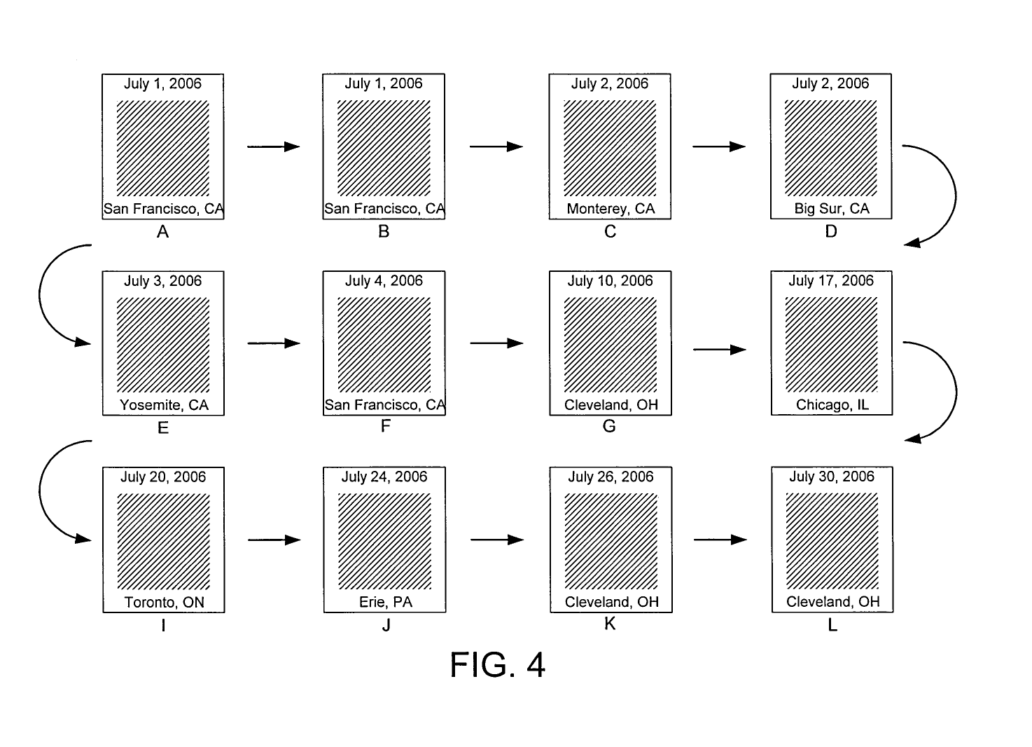

For example, turning to FIG. 4, in accordance with an exemplary embodiment of the present invention, a video-based diary is illustrated consisting of only image related events. In this embodiment, the date and location of each image along with the image itself comprises each of the scenes A-L. Accordingly, scenes A and B represent images that were taken in San Francisco, on Jul. 1, 2006. Scene C represents an image taken in Monterey, Calif. on Jul. 2, 2006. Scene D represents an image that was taken in Big Sur, Calif. on Jul. 2, 2006. The remaining Scenes E-L represent images taken on various dates in various locations, as illustrated. Each scene can be displayed for a desired period of time and transitions between the scenes can be automatically added by the application. Similarly, borders surrounding the images can also be included.

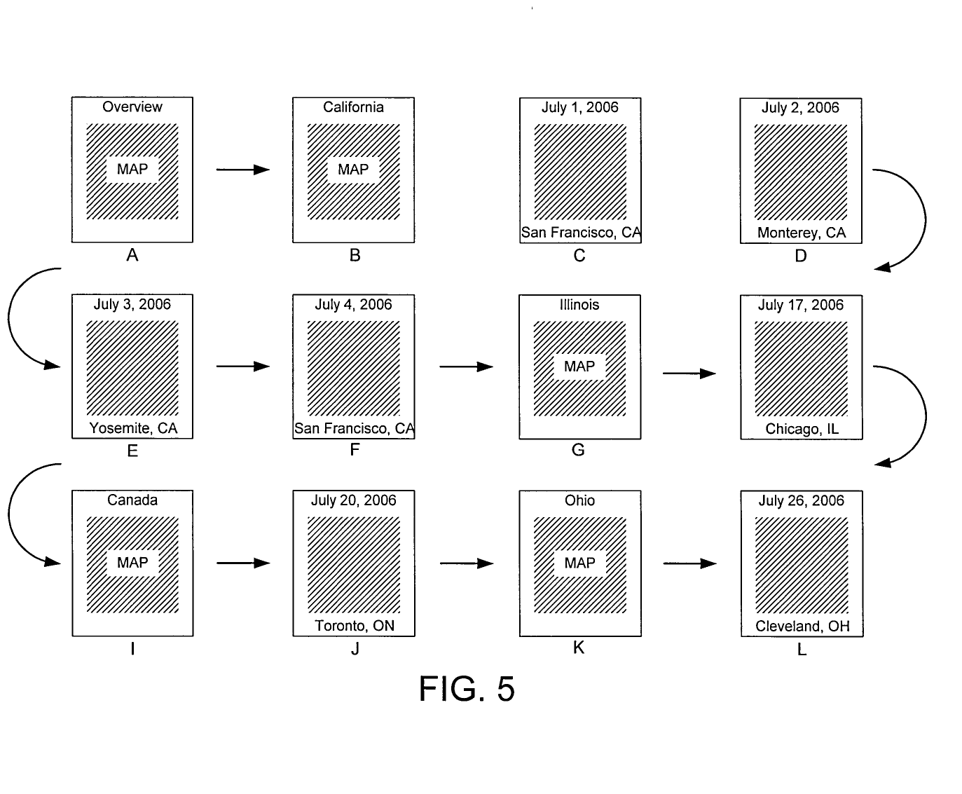

Turning now to FIG. 5, yet another exemplary generated video-based diary 60 in accordance with an aspect of the invention is illustrated. In this embodiment, some of the scenes give information and/or graphics that are generated and/or assembled by the application. By way of example, consider the situation of a user traveling about the country taking pictures and/or video with the mobile phone 10. Each picture and/or video as stored in the memory 38 includes not only the image or video itself, but also information associated with the location of the phone and the time and date on which the image was taken. Accordingly, the generated video-based diary 60 can insert scenes, such as scenes A and B, so as to enhance the presentation of the information. Scene A, for instance, can be a map of the entire country with markers on the map corresponding to locations at which one or more of the events (e.g., photos) depicted in the remaining scenes occurred. Scene B can be an enlarged portion of the map of scene A, for example California, illustrating in greater detail the locations in California where at least one of the following events that are the subject of subsequent scenes occurred. The subsequent scenes C, D, E and F, therefore, are all images and/or video taken in California. Each scene also includes, to the extent possible, a city or location within California where the image was captured. Scene G is again an enlarged portion of the map of scene A showing in more detail the locations within Illinois where at least one of the following events that are the subject of subsequent scenes occurred. Accordingly, scene H corresponds to a picture that was taken in Chicago. Scene I includes a map of Canada with a marker illustrating the location of at least one of the events of the subsequent scenes. Accordingly, Scene J represents an image and/or video that was captured in Toronto. Finally, scene K includes a map that is an enlarged portion of the map of scene A illustrating locations in Ohio where at least one event of the subsequent scenes occurred. Accordingly, scene L represents an image and/or video taken in Cleveland, Ohio.

It will be appreciated that the generated video-based diaries 60 as described can also include a wide variety of special effects and/or transitions between consecutive scenes. For example, a simple transition between consecutive scenes would be a fade-out of one scene and a fade-in to the next scene. Similarly, a dissolve transition may be used. Another possibility would be for the clock to advance rapidly and continuously while the content of each scene changes corresponding to the various events that occur. Links to additional content, such as the full text of email and/or text messages can also be embedded in the scenes so that a user can select the link to obtain the additional information.

It will also be appreciated that the generated video-based diary 60 can include a soundtrack. The soundtrack may include segments of songs listened to by the user during the same time period that the diary 60 covers. Alternatively, the soundtrack can be composed of the most played song and/or new songs recently added to the mobile phone 10. The user may also designate a particular soundtrack corresponding to a popular music chart. For example, the weekly top 10 songs.

The generated video-based diary 60 can include any and all information stored in memory 38, as desired. Alternatively, the user may select only certain event types and data to be included in the video-based diary 60. For example, the user may not want the content of messages to be displayed in the diary 60. Accordingly, the user can designate that such information not be included in the diary 60. Similarly, location information can be excluded from the diary 60, for example.

It will be appreciated that a wide variety of templates can be provided for generating the video-based diary 60. For example, various themes relating to places such as the beach, the mountains, the desert, etc. can be used. Such templates may include background art (e.g., beach ball, mountains, cactus, etc.) corresponding to the respective templates. Other templates relating to sports teams or life events such as graduations, weddings, anniversaries, birthdays, etc. can also be provided.

Additional information and/or data can also be retrieved by the mobile phone 10 via the internet and included in the video-based diary 60. For example, headlines of the day's news can automatically be downloaded and inserted as scenes in the generated video-based diary 60. Similarly, sports scores and/or the day's history and/or trivia can be inserted into the diary 60. In general, the information received from the internet and incorporated into the diary 60 can be specified by the user.

A generated video-based diary 60 in accordance with the invention provides a summary of the user's use of the mobile phone 10 during a given time period. In many cases, the user's use of the phone is highly illustrative of the user's activities. Accordingly, the diary 60 functions as a sort of synopsis of the user's life for the periods covered. The video-based diary 60 can be stored in the memory 38 of the mobile phone 10 or can be uploaded to a personal computer and/or the internet. By way of example, the video-based diary can be uploaded to a user's blog on the internet. It will be appreciated that the user can tailor the application so that only information that the user wants to make available on the blog is included in the generated video-based diary 60. As such, the user also can conduct the usage of the phone with the premise in mind that the video-based diary 60 will be published on the internet. In this regard, the user may take pictures and/or videos that relate to or correlate with content already existing on the user's blog. For example, if the user has a blog with a primary topic being exotic automobiles, the user may take pictures and/or video of exotic automobiles throughout the day such that the generated video-based diary 60 contains content directly relevant to the user's blog. In other instances, the user may have a blog which is in itself essentially a diary of the user's life. Accordingly, the user may wish to upload a video-based diary 60 of all his activities during a given time period or day, such as the video-based diary 60 illustrated in FIG. 3.

It will be appreciated that the video-based diary can be particularly useful to executives, attorneys, and other professionals for tracking time to be billed to a client. In this regard. a video-based diary of the executive's work related activities could be generated and sent to an administrative assistant who could then use the diary to bill clients for the executive's time. For example, a typical diary could include all of the calls the executive made to various clients during the day. The duration of each such could be used to determine how much time to bill each respective client. In the same manner, sent and received emails could be utilized for billing purposes. Location data could also be used provided that it could be confirmed that the executive was actually working on a particular client's matter while at the location.

The video-based diary can be stored in any suitable file format, such as mpeg video, for example. In this regard, the video-diary can be fully animated with transitions between various scenes ad the like.

Specific embodiments of the invention have been disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method of generating a video-based diary of user data stored in a memory of an electronic equipment comprising:
selecting at least one type of user data to be included in the diary; and
generating at least one video-based scene using the at least one type of user data;
wherein the at least one video-based scene includes at least a portion of the at least one type of user data selected.

2. A method as set forth in claim 1, further comprising selecting at least one period of time for the diary.

3. A method as set forth in claim 1, wherein the at least one type of user data includes call log data, message log data, video/picture log data, MP3 log data, location log data, environmental log data, calendar log data, and voice memo log data.

4. A method as set forth in claim 1, further comprising downloading user-defined data from the internet, and generating at least one scene including at least a portion of the downloaded data.

5. A method as set forth in claim 1, further comprising generating a scene in response to information contained in the at least one type of user data.

6. A method as set forth in claim 5, wherein the generating a scene includes generating a map based upon location information.

7. A method as set forth in claim 1, further comprising selecting at least one audio file to be included in the at least one video-based scene.

8. A method as set forth in claim 7, wherein the selecting at least one audio file includes selecting the file based upon information in an MP3 log stored in the memory.

9. A method as set forth in claim 1, further comprising transferring the at least one video-based scene to another electronic equipment.

10. A method as set forth in claim 1, further comprising uploading the at least one video-based scene to the internet.

11. A method as set forth in claim 1, further comprising associating a link with the at least one scene, wherein the link links to a different scene of the video-based diary.

12. A method as set forth in claim 11, wherein the different scene contains additional data related to the user data contained in the scene with the associated link.

13. An electronic equipment comprising:
a memory for storing at least one type of user data;
a processor; and
a software application stored in the memory and configured to generate a video-based diary including at least one scene containing data from at least one type of user data stored in the memory.

14. An electronic equipment as set forth in claim 13, wherein the at least one type of user data includes call log data, message log data, video/picture log data, MP3 log data, location log data, environmental log data, calendar log data, and voice memo log data.

15. An electronic equipment as set forth in claim 13, wherein the software application is configured to generate a scene in response to information contained in the at least one type of user data.

16. An electronic equipment as set forth in claim 13, wherein the at least one scene includes audio from at least one audio file stored in the memory.

17. An electronic equipment as set forth in claim 13, wherein the software is configured to associate a link with the at least one scene, and wherein the link links to a different generated scene of the video-based diary.

18. An electronic equipment as set forth in claim 13, wherein the electronic equipment is a mobile phone.

19. An electronic equipment as set forth in claim 13, wherein the electronic equipment is at least one of a personal audio device, a personal video device or a personal digital assistant.
